(19) United States
(12) Patent Application Publication
(10) Pub. No.: US 2015/0066615 A1
(43) Pub. Date: Mar. 5, 2015

(54) Method for syndicating posts on a social network site

(71) Applicants: Devkumar Gandhi, Fremont, CA (US); Udaya Nayak, Milpitas, CA (US); Ravi Shankar Mishra, Sunnyvale, CA (US)

(72) Inventors: Devkumar Gandhi, Fremont, CA (US); Udaya Nayak, Milpitas, CA (US); Ravi Shankar Mishra, Sunnyvale, CA (US)

(21) Appl. No.: 14/013,021

(22) Filed: Aug. 28, 2013

(51) Int. Cl. G06Q 50/00; G06Q 30/02

(52) U.S. Cl. CPC G06Q 50/01; G06Q 30/0214; G06Q 30/0277
USPC 705/14.16

(57) ABSTRACT

A method for syndicating promotional posts on a social network site is disclosed. This method may allow individual influencers on the social network site to be paid for allowing advertisers to add promotional posts to their social network feeds. The method may allow advertisers to select particular boards or categories and approve particular promotional posts.

### BACKGROUND OF THE INVENTION

1. Field of the Invention

The present invention relates generally to computer systems. In particular, the present invention relates to a method for syndicating promotional posts on a social networking site.

2. Description of the Related Art

Social network sites have become extremely popular. Many social networking sites allow some form of advertising. On some social network sites there are banner or textual context-based advertisements brokered by the social network provider. On some social networking sites there are “sponsored” posts from paid advertising. Some influencers have been able to monetize their presence on a social networking site by directly soliciting sponsors to promote on their social network feed. Some social networking sites provide a pinboard format of images, while other social networking sites provide text and mixed media posts.

### SUMMARY OF THE INVENTION

A method for syndicating promotional posts on a social network site is disclosed.

According to one embodiment, an advertiser opens an application or web browser on an advertiser device, preferably a personal computer or smartphone. The advertiser sends a request to a syndication provider to place a promotional post. The influencer sends a request to a syndication provider and provides authentication credentials for a social networking site, preferably a username and password or an API authentication token. The syndication provider then checks the promotional post and the influencer against evaluation criteria. If these criteria match, the syndication provider sends a request to the social networking site to post the promotional post to the influencer's social network feed. This promotional post preferably links to a URL of the syndication provider so that when end users of the social networking site select the promotional post, the syndication provider receives a request and uses these requests to calculate analytics and billing information.

In certain embodiments, the social networking site provides an API to allow third parties to post to social networking feeds, and the syndication provider preferably submits promotional posts using this API. In other embodiments, the social networking site does not provide an API, and the syndication provider uses a publicly available Web interface to submit the promotional posts.

### BRIEF DESCRIPTION OF THE FIGURES

FIG. 1 is a block diagram of a preferred embodiment of a system for syndicating promotional posts on a social networking site.

FIG. 2 is a flowchart describing an operation scenario of the preferred embodiment shown in FIG. 1.

FIGS. 3-4 show exemplary screenshots of an interface allowing influencers to connect to their social media accounts and select boards on which to allow promotional posts.

FIG. 5 shows an exemplary email notification sent to influencers to alert each influencer that a promotional post awaits their approval.

FIG. 6 shows an exemplary screenshot of an interface allowing influencers to monitor promotional posts.

FIG. 7 shows an exemplary screenshot of an interface allowing payment activity to be monitored.

FIGS. 8-10 show exemplary screenshots of an interface for advertisers to create an advertisement.

### DETAILED DESCRIPTION

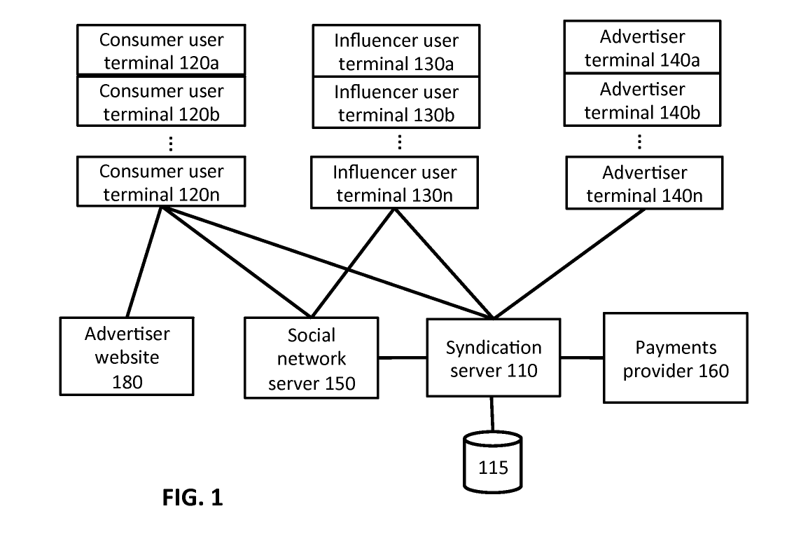

FIG. 1 is a block diagram of a preferred embodiment of a system for syndicating promotional posts on a social networking site.

Syndication server 110 processes user and advertisement information. In a preferred embodiment it receives and responds to requests for offer and user information and processing from users, sponsors, and vendors. In certain embodiments syndication server 110 may be a cluster of servers, preferably managed by way of a load balancer, or a virtual machine to be run on a grid of servers in a cloud computing-style system. The functionality of syndication server 110 may also be divided into multiple logical units, potentially run by independent systems. For example, social networking services may provide single sign-on functionality on an independent server; captcha services may provide captcha functionality on an independent server; user-, vendor-, and sponsor-facing components may be hosted on different servers or on mirrored servers or on a content distribution network. In a preferred embodiment, syndication server 110 is a, Windows™ or Linux™ system running a Java™ virtual machine, Tomcat™ application server to host web services to respond to REST requests using XML messages, and Apache™ web server.

Database 115 represents backend storage for the functionality of syndication server 110. Data stored by database 115 for each influencer includes name, password, social network login credentials, enabled boards (social network feeds on which promotional posts may be posted), enabled categories, approved promotional posts, payment information, tax information, and account balance. Data stored by database 115 for each advertiser includes name, password, billing information, account balance, and submitted promotional posts. Data stored by database 115 for each promotional post includes any applicable spending or time limits, whether to notify the advertiser when these limits are near, image, description, clickthrough URL, redirect URL, and relevant categories. Database 115 is preferably a standard relational database such as MySQL™, but may also be a flat file or a distributed storage service such as Amazon S3™ (Simple Storage Service) or Amazon SimpleDB™, or another type of database. Database 115 may be divided into multiple locations or functionalities.

Each consumer user terminal 120a . . . 120n corresponds to an Internet-connected computer or interactive device such as a mobile phone, tablet, laptop PC, desktop PC, television, or other electronic device with a web browser or an application for offer distribution. In certain embodiments, some user terminals may be smartphones. In certain embodiments multiple user terminals will be connected to the network simultaneously.

Each consumer user terminal 120a . . . 120n is connected to advertiser website 180, social network server 150, and syndication server 110 through one or more networks, preferably the Internet. In certain embodiments this link may be a cellular data link such as GSM (Global System for Mobile communication), GPRS (General Packet Radio Service), 1xEV-DO, UMTS (Universal Mobile Telecommunications System), LTE (Long Term Evolution), or other cellular data systems as will be apparent to one having skill in the art.

Preferably, each consumer uses a consumer user terminal 120a . . . 120n to browse the social network on social network server 150 using a Web browser. When the consumer clicks on a promotional post, the post links to a URL on syndication server 110, which tracks the request and then redirects the consumer to advertiser website 180.

Each influencer user terminal 130a . . . 130n corresponds to an Internet-connected computer or interactive device such as a mobile phone, tablet, laptop PC, desktop PC, television, or other electronic device with a web browser or an application for offer distribution. In certain embodiments, some user terminals 130a . . . 130n are smartphones. In certain embodiments multiple user terminals will be connected to the network simultaneously.

Each influencer user terminal 130a . . . 130n is connected to social network server 150 and syndication server 110 through one or more networks, preferably the Internet. In certain embodiments this link may be a cellular data link such as GSM (Global System for Mobile communication), GPRS (General Packet Radio Service), 1xEV-DO, UMTS (Universal Mobile Telecommunications System), LTE (Long Term Evolution), or other cellular data systems as will be apparent to one having skill in the art.

Preferably, each influencer uses an influencer user terminal 130a . . . 130n to sign up for syndication of promotional posts on the influencer's social network feed, to approve individual promotional posts, and to manage the payments the influencer receives for allowing promotional posts to be posted on the influencer's social network feed.

Each advertiser terminal 140a . . . 140n corresponds to an Internet-connected computer or interactive device such as a mobile phone, tablet, laptop PC, desktop PC, television, or other electronic device with a web browser or an application for offer distribution. In certain embodiments, user terminals 140a . . . 140n are smartphones. In certain embodiments multiple user terminals will be connected to the network simultaneously.

The influencer user terminal 140n is connected to syndication server 110 through one or more networks, preferably the Internet. In certain embodiments this link may be a cellular data link such as GSM (Global System for Mobile communication), GPRS (General Packet Radio Service), 1xEV-DO, UMTS (Universal Mobile Telecommunications System), LTE (Long Term Evolution), or other cellular data systems as will be apparent to one having skill in the art.

Preferably, an advertiser uses the advertiser terminal 140n to sign up for syndication of promotional posts on influencers' social network feeds and to manage payment of the costs for syndication of promotional posts.

Social network server 150 is preferably a major social networking service such as Pinterest™, Facebook™, or LinkedIn™. In an even more preferred embodiment social network server 150 allows users to share posts though image pinboards. Social network server 150 is used by consumers and influencers through its normal Web and dedicated app interfaces from consumer user terminal 120n and influencer user terminal 130n. Social network server also receives requests to add and remove posts from syndication server 110; in some embodiments, this communication with syndication server 110 takes place through a dedicated API (application programming interface), whereas in other embodiments communication with syndication server 110 takes place through automation of the social network server's ordinary Web interface (e.g. “scraping”). In some embodiments, social network server 150 may also provide a centralized authentication service such as Facebook Connect™ to allow influencers and/or advertisers to log in to syndication server 110.

Payments provider 160 processes payments from the advertiser and payments to the influencer. Payments provider 160 is connected to syndication server 110 through a communication network such as the Internet or the public switched telephone network. Preferably payments provider 160 is a system such as PayPal which enables syndication server 110 to request both payments from the advertiser and to the user. In certain embodiments multiple payments providers may be used, for example to allow advertisers to select between multiple forms of payment or to allow inbound and outbound payments to be processed by different companies.

Advertiser website 180 is a Web server, group of Web servers, or a similar system as will be apparent to one having skill in the art. The advertiser uses advertiser website 180 to provide more detailed information about products and services promoted by promotional posts.

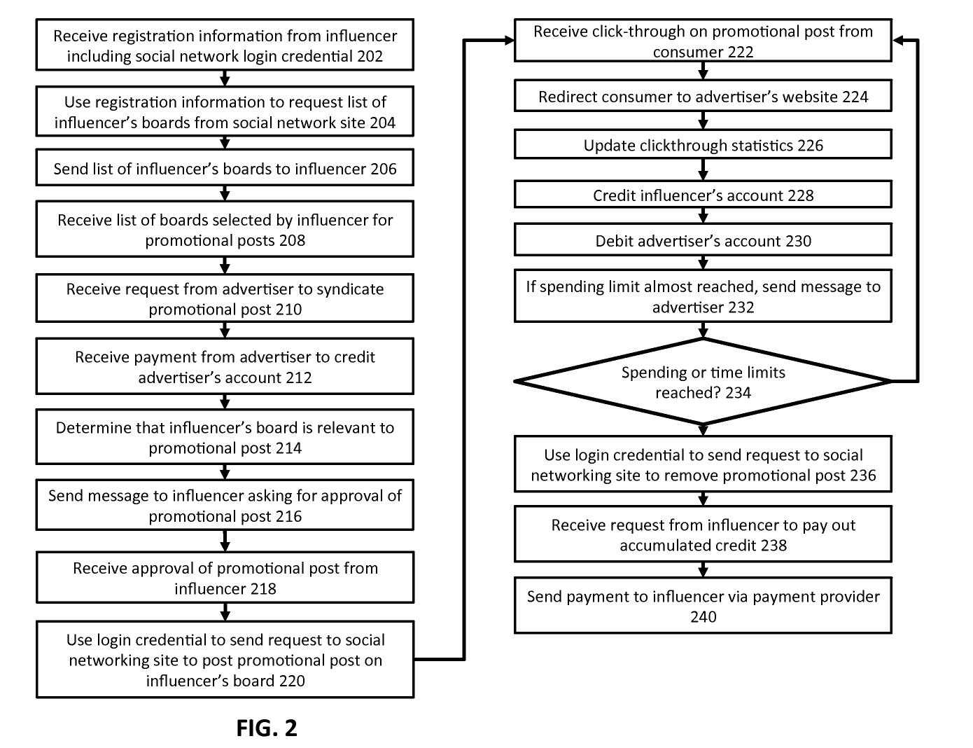

FIG. 2 is a flowchart describing an operation scenario of the preferred embodiment shown in FIG. 1. As will be apparent to one having skill in the art, the particular order of operations depicted is not necessarily mandatory: for example, an influencer may wish to register after a promotional post has already been submitted to syndication server 110 or to receive payment before the promotional post has been removed.

In step 202, syndication server 110 receives registration information from influencer user terminal 130n. As part of this registration information, the influencer provides a social network login credential so that syndication server 110 may submit requests to social network server 150 on the influencer's behalf. This social network login credential may comprise a username and password, or it may use other types of authentication tokens such as those provided through the Facebook Connect™ platform.

In step 204, syndication server 110 requests a list of the influencer's social network feeds from social network server 150.

In step 206, syndication server 110 sends the list of the influencer's social network feeds and a list of categories to influencer user terminal 130n. This step allows the influencer to limit promotional posts to certain social network feeds or categories.

In step 208, syndication server 110 receives the influencer's selection of social network feeds and categories from influencer user terminal 130n.

In step 210, syndication server 110 receives a request from advertiser terminal 140n to syndicate a promotional post. This request typically will include a name for the ad, a redirect (“destination” URL), artwork to post on the social network feed, a text message, categories, a start date, a budget, optionally an end date, and optionally a request to notify the advertiser when the promotional post is about to expire. This request may also include payment information so that the advertiser can pay for syndication of the promotional post.

In step 212, syndication server 110 receives payment from the advertiser. In a preferred embodiment, each promotional post is prepaid with a specific budget, and payment is made at the time of posting. In alternative embodiments, the advertiser may be billed later, or a prepaid balance may be shared among multiple promotional posts.

In step 214, syndication server 110 selects the influencer's boards that are relevant to the promotional post based on the influencer's selection of which boards and categories are acceptable for promotional posts. Preferably, each promotional post will be posted on the boards of several influencers.

In step 216, syndication server 110 sends a message to influencer user terminal 130n asking for approval of the promotional post. In a preferred embodiment, this message is sent by e-mail to the influencer's e-mail address, and is also displayed in a list of posts pending approval when the influencer logs in to the syndication server's Web interface. The message preferably includes a link to the syndication server to approve the individual promotional post to be approved, and preferably also includes a link to the syndication server to approve all promotional posts pending approval by the influencer.

In step 218, influencer user terminal 130n sends a message to syndication server 110 indicating the influencer's approval of the promotional post.

In step 220, syndication server 110 uses the login credential to send a request to the social networking site to post the promotional post on the influencer's board. In a preferred embodiment, this request is sent by automatically logging into the social networking site's public HTTPS Web interface on the influencer's behalf and submitting the promotional post through the social networking site's Web interface. In alternative embodiments, this request may take place through a published API such as Facebook Connect, which may use any of a number of protocols and formats such as HTTP, HTTPS, JSON, SOAP, XML, and other formats. In a preferred embodiment, a custom URL on syndication server 110 is assigned to redirect traffic through syndication server 110 to advertiser website 180, and this custom URL is added to the promotional post when the request is sent to the social networking site. A custom URL for the promotional post may be specific to each influencer to better track clicks, or a custom URL for the promotional post may be shared across all users to simplify the implementation or to allow for a shorter, easier-to-read URL. In a preferred embodiment, the advertiser's submitted image is also uploaded to the social networking site. Alternatively, if the social networking site supports linking to images, the image may instead be hosted on syndication server 110, which would allow the number and source of impressions to be tracked through analysis of image requests to syndication server 110.

Step 222 takes place once consumers have seen the promotional post on the social networking site and click on the link. Syndication server 110 receives an HTTP or HTTPS request from consumer user terminal 120n. Syndication server 110 then sends a response to consumer user terminal 120n redirecting the consumer's Web browser to advertiser website 180 in step 224. For each request, syndication server 110 adds to the clickthrough statistics for the influencer and promotional post in step 226, preferably also keeping track of the HTTP Referer field (indicating the page on social network server 150 from which the consumer clicked or tapped on the promotional post), the user agent (indicating which type of device consumer user terminal 120n is), and the source IP address of the request (to understand the geographic location of consumer user terminal 120n, potentially in conjunction with a third-party IP-to-location service, and to help remove duplicate and fraudulent requests.) Syndication server 110 may also use cookies or a third-party centralized identity service such as the Facebook Connect platform to help detect unique users who click on the promotional post. In some embodiments the advertiser website itself may be hosted on syndication server 110.

In some embodiments syndication server 110 may redirect the consumer to a URL containing tracking information in step 224 so that the conversion rate of users may be tracked. In some embodiments this tracking information may be used to reward influencers when a consumer purchases a product or performs another desired action after clicking on the promotional post. In some embodiments this tracking information may be used to provide more detailed statistics to advertisers about the activities of consumers after they click on a promotional post.

In step 228, syndication server 110 credits the influencer's account by an amount. In a preferred embodiment, this amount is monetary, though it is also possible that non-monetary rewards such as promotional points or charitable donations could be provided. In a preferred embodiment, the amount credited to the influencer for each click is based at least in part on the category of the promotional post. In other embodiments, a cost-per-impression model or hybrid model is used, and the amount credited is based at least in part on the number of views of the promotional post.

In step 230, syndication server 110 debits the advertiser's account by an amount. In a preferred embodiment, this amount is monetary, though it is also possible that non-monetary forms of payment such as promotional credit could be used. In a preferred embodiment, the amount debited to the advertiser for each click is based at least in part on the category of the promotional post. In other embodiments, a cost-per-impression model or hybrid model is used, and the amount debited is based at least in part on the number of views of the promotional post.

In a preferred embodiment, steps 226, 228, and 230 involve a fraud detection system to ensure that influencers cannot engage in click fraud and illegitimately get paid. In a preferred embodiment, this fraud detection system uses criteria such as common IP addresses to disallow certain clicks as likely to be fraudulent.

In step 232, syndication server 110 checks any spending limit for the promotional post, and if it has almost been reached, sends a message to advertiser terminal 140n to alert the advertiser. In a preferred embodiment, this message is an e-mail sent to the advertiser's registered e-mail address. In a preferred embodiment the spending limits are set separately for each promotional post. In some embodiments spending limits may instead be shared among posts. In some embodiments time this check may be performed for a time limit instead of a spending limit. In a preferred embodiment, the advertiser checks a box to opt in or out of the messages in step 232 when creating the ad through syndication server 110's Web management interface, and a message is not sent unless the advertiser has opted in.

In step 234, syndication server 110 checks any time or spending limits for the promotional post, and checks to see if the advertiser has requested that the promotional post be removed. If the limits have not yet been reached and the advertiser has not requested the promotional post's removal, syndication server 110 continues to receive clickthroughs, returning to step 222. Otherwise, syndication server 110 proceeds to step 236 to effect removal of the promotional post.

In step 236, syndication server 110 uses the login credential to send a request to social networking site 150 to remove the promotional post. In a preferred embodiment, this takes place over the same interfaces used in step 220.

In step 238, influencer terminal 130n sends a request to syndication server 110 requesting that the influencer's account balance be paid out.

In step 240, in response to the request of step 238, the influencer's account balance is paid out. In a preferred embodiment, syndication server 110 sends a message to payments provider 160 to effect a payment to the influencer's bank account. In some embodiments, the payout may happen automatically when the influencer's account balance reaches a preset level such as $20 or on a preset schedule, such as once per month. In some embodiments, a nonmonetary award may be provided to the user in this step: for example, a user might redeem promotional points for a prize, and this prize could be shipped to the user, or a user might redeem promotional points for a gift certificate to be delivered over e-mail.

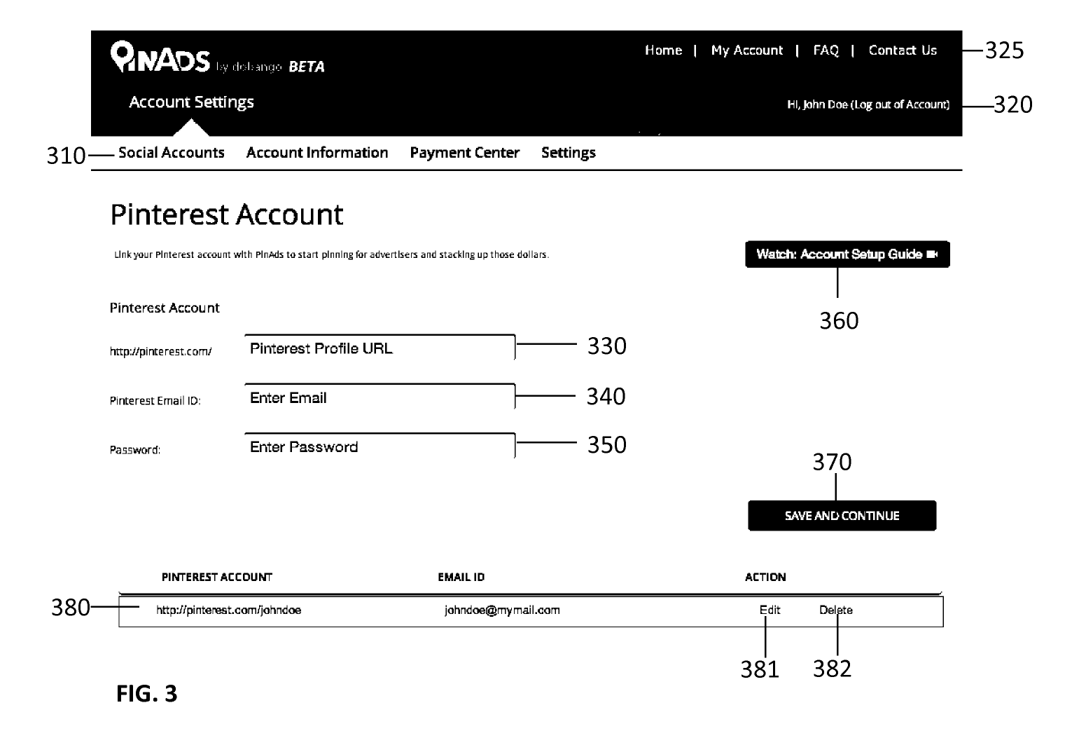

FIG. 3 shows an exemplary screenshot of a Web interface allowing influencers to connect to their social network site accounts. Menu bar 310 is a navigation interface on which the “Social Accounts” option is selected, bringing the influencer to the screen in FIG. 3. Link 320 allows the influencer to log out of his or her account. Navigation bar 325 provides links to other areas of syndication server 110. Text box 330 receives the user name of the influencer; text box 340 receives the email ID of the influencer, and text box 350 receives the password of the influencer. Button 360 opens a help video to provide guidance for the user. When the text boxes have been populated, the influencer may click button 370 to proceed and add this account to list of accounts 380. Accounts in list of accounts 380 may be edited by clicking link 381 or deleted by clicking link 382.

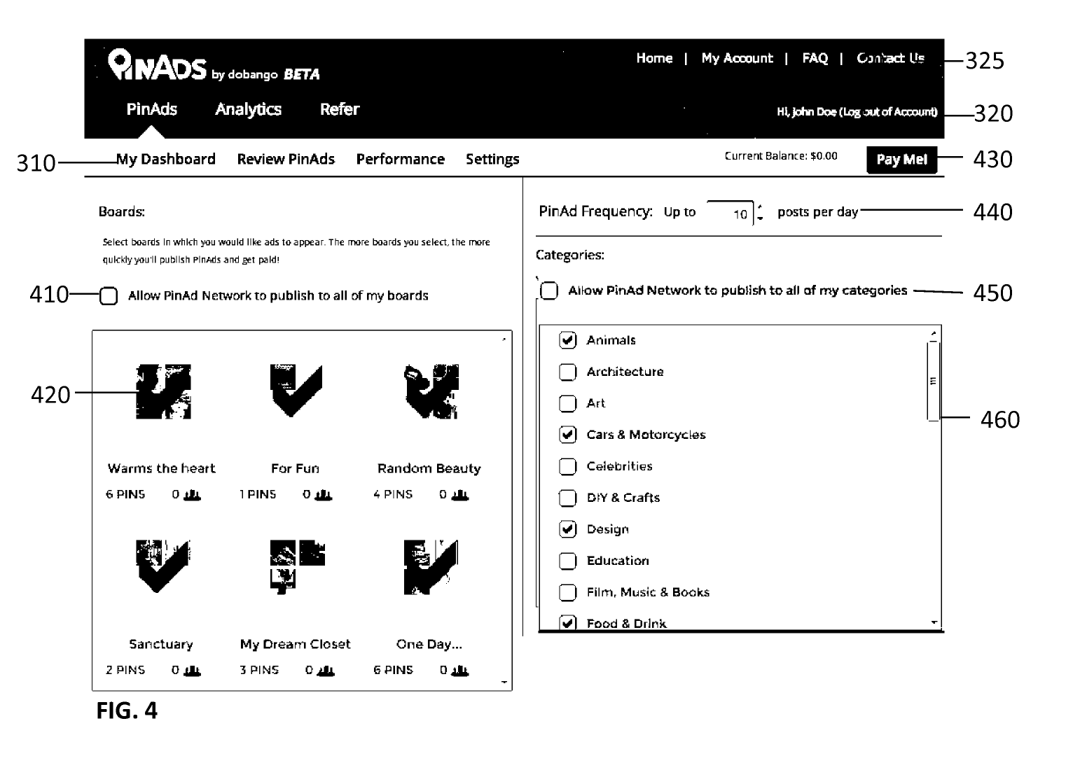

FIG. 4 shows an exemplary screenshot of a Web interface allowing influencers to select boards to allow promotional posts on. Elements 310, 320, and 325 are as described in previous Figures. In list 420, a list of the influencer's boards is displayed as obtained from social network server 150. The influencer can click on boards within list 420 to select or deselect them for posting of promotional posts, or the influencer can check checkbox 410 to allow posting to all boards. Button 430 displays the influencer's current account balance and triggers payout as disclosed in step 238 of FIG. 2. Text box 440 allows the influencer to select a maximum number of posts to be posted on their boards each day.

List 460 displays a list of categories to allow posting of promotional posts to. The influencer can click on individual categories to select or deselect them. The influencer can also check checkbox 450 to allow posting to all categories.

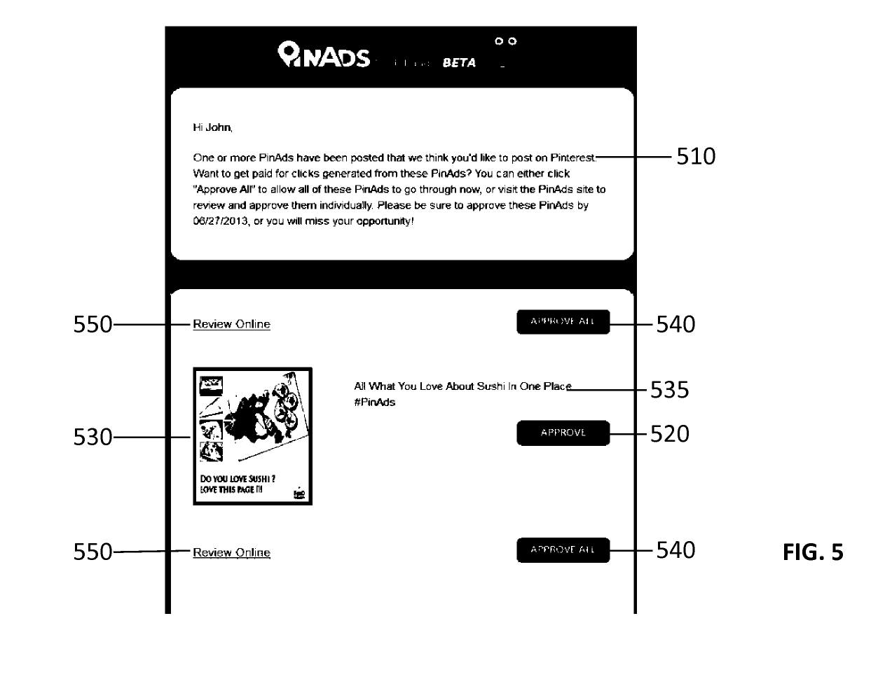

FIG. 5 shows an exemplary email notification sent to an influencer to alert the influencer that a promotional post awaits their approval. It contains an introductory text 510 explaining how to approve promotional posts. Link 550 takes the influencer to the corresponding Web interface. The image of a promotional post is displayed in box 530, and the text of the promotional post is displayed in label 535. The user may approve this promotional post by clicking button 520. Other promotional posts may also be displayed in the same email. To approve all of them, the influencer may click button 540.

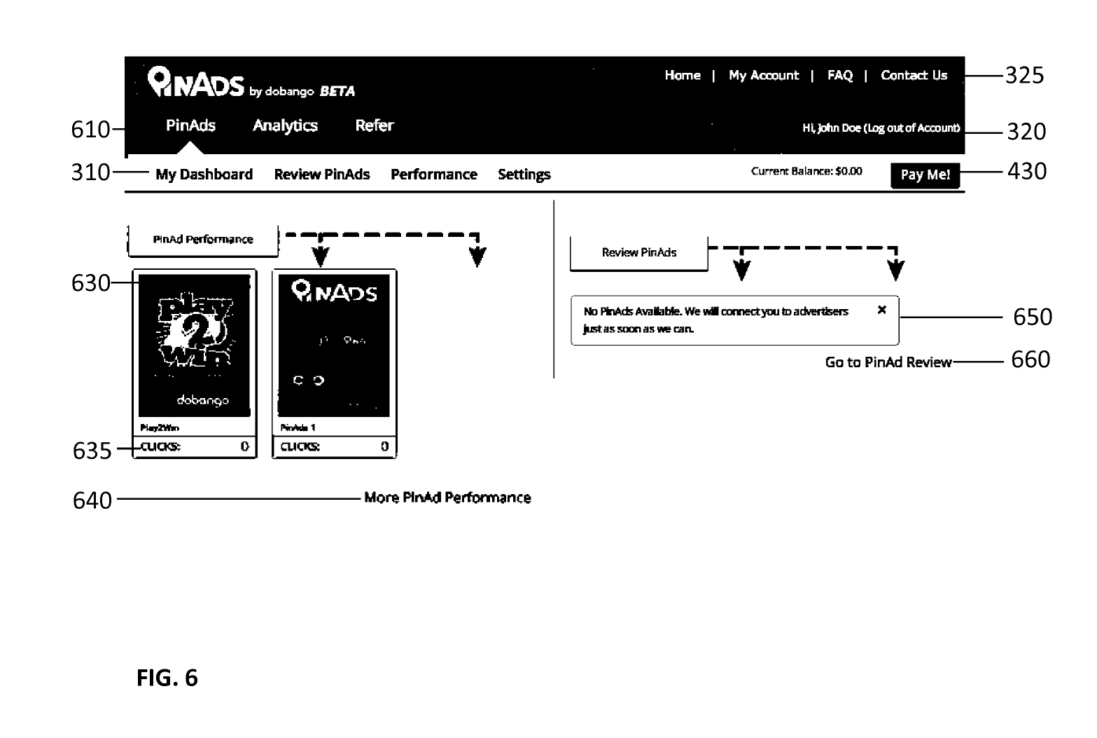

FIG. 6 shows an exemplary screenshot of an interface allowing influencers to monitor promotional posts. Navigation bar 610 allows navigation of the Web site. Elements 310, 320, 325, and 430 are as previously described. Promotional posts currently posted to the influencer's social network feed are listed in area 630, and the number of clicks received on each post is shown in label 635. Link 640 takes the user to a more detailed view of performance.

List 650 shows a list of any promotional posts currently awaiting the influencer's approval. Link 660 takes the influencer to a review screen similar to the email notification in FIG. 5.

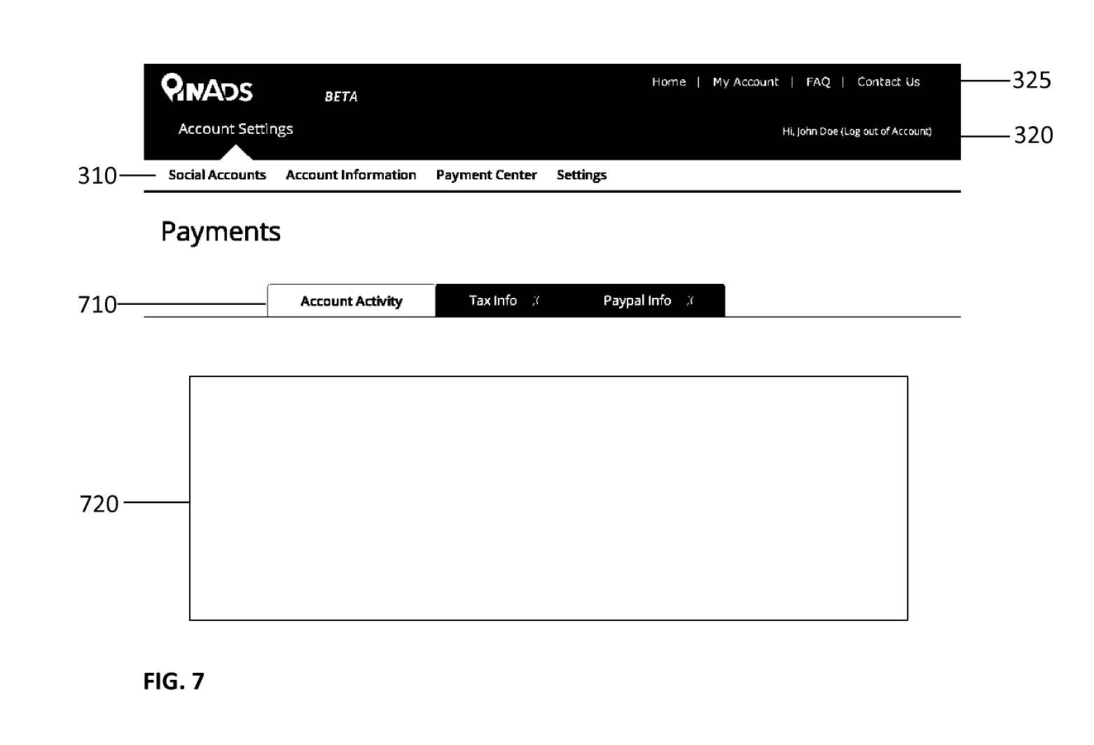

FIG. 7 shows an exemplary screenshot of an interface allowing payment activity to be monitored. Elements 310, 320, and 325 are as previously described. Element 710 allows a user to select the viewing of historical account activity, tax documents, or information about the configuration of payments provider 160 such as a user name and password or account number to deposit payments into. Element 720 displays the selected information.

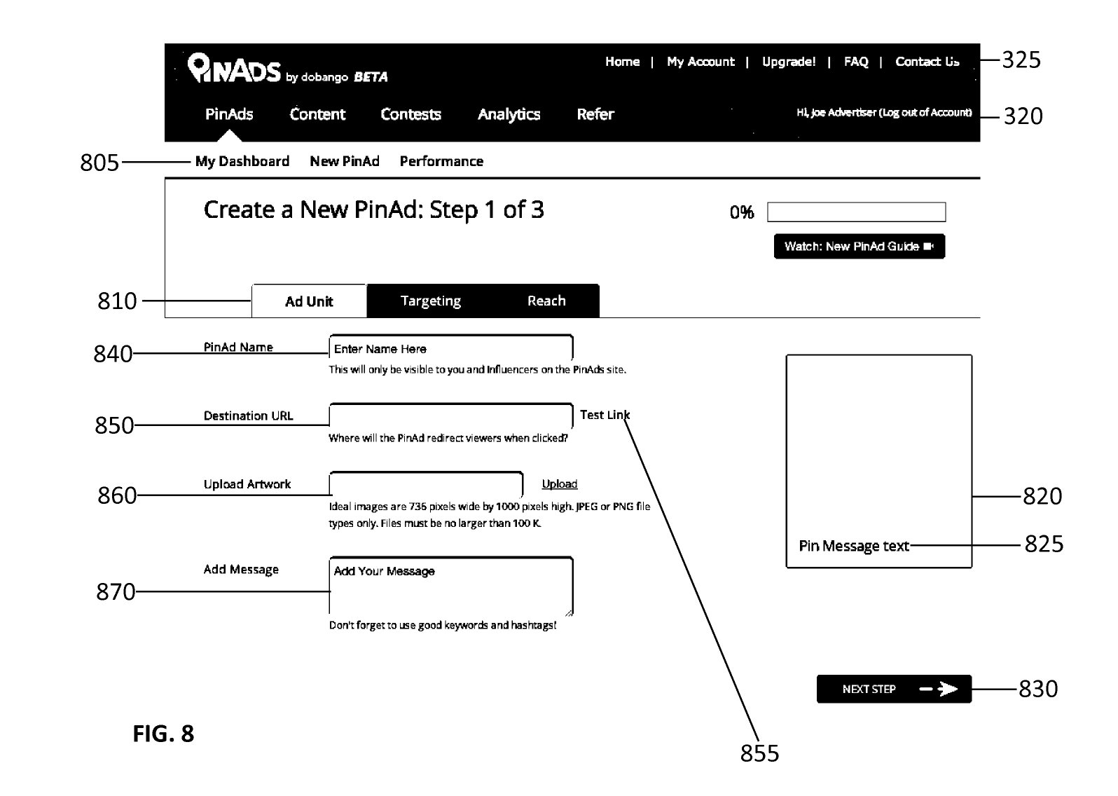

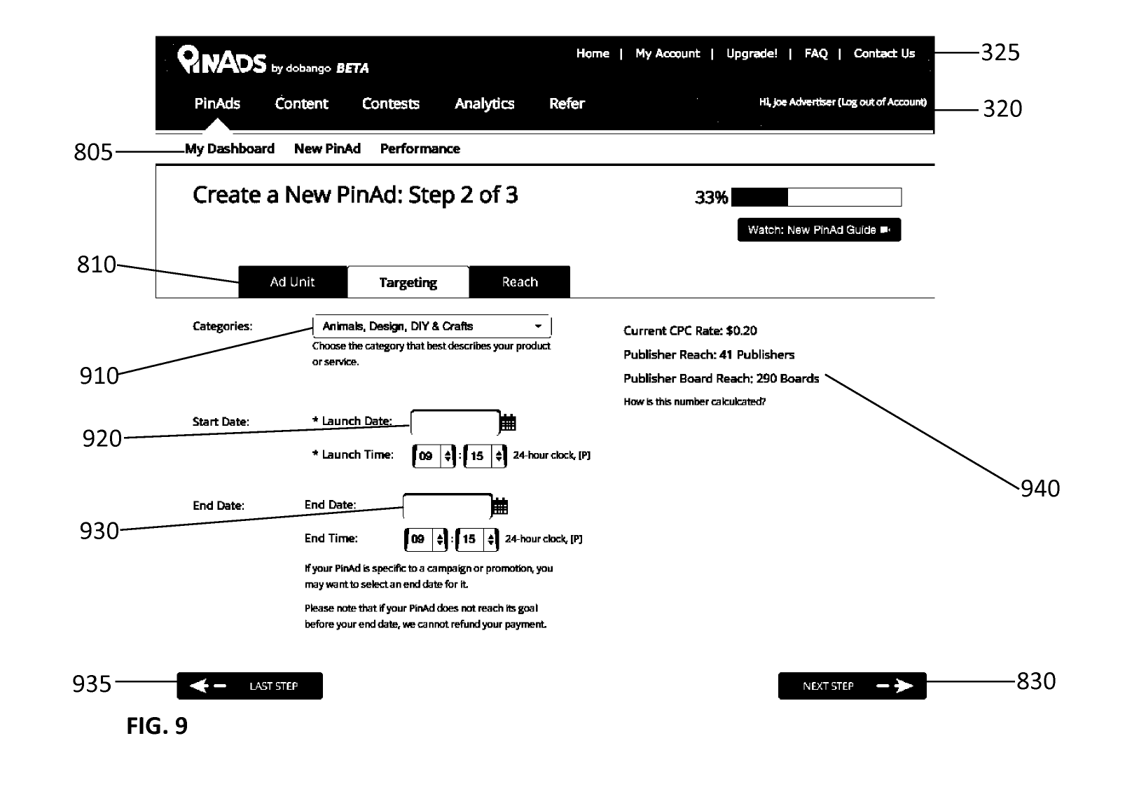

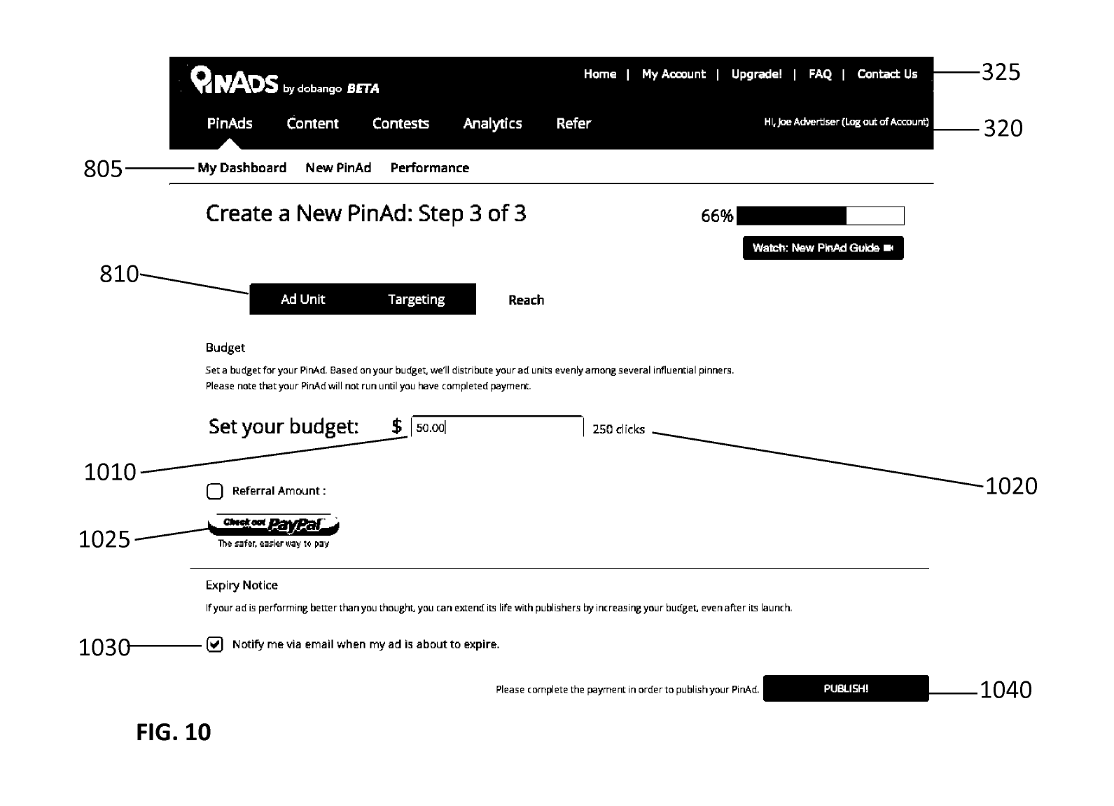

FIGS. 8-10 show exemplary screenshots of a three-step interface for advertisers to create a promotional post. Elements 320 and 325 are as previously described. Element 805 provides an interface to select different account management functions and create new promotional posts. Element 810 allows the advertiser to select between the three steps, and button 830 allows the advertiser to advance to the next step. The advertiser uploads an image through text box 860, and the image is displayed in image box 820. Images are preferably 736 pixels wide by 1000 pixels high, and are preferably uploaded in JPEG or PNG format. The advertiser provides a title in text box 870, and the title is displayed in label 825. The promotional post's name is entered in text box 840, and a URL linking to advertiser website 180 is provided in text box 850. The advertiser may test this URL by clicking link 855, which will take the advertiser to the entered URL. In the second step, categories are selected from dropdown list 910. Based on the selected categories, information about cost per click, number of influencers, and number of boards are automatically displayed in element 940. Start and end dates and times can be specified in date pickers 920 and 930. If a start time is not specified, the promotional post is sent to influencers for approval and posting immediately. If an end time is not specified, the promotional post continues to be posted until the spending limit has been reached or the post is explicitly removed by the advertiser. Button 935 takes the user back to step 1. In the third step, the advertiser sets a spending limit in text box 1010, and label 1020 is updated to show how many clicks this budget will cover. Check box 1030 allows the advertiser to opt in to the emails described in step 232 of FIG. 2. In a preferred embodiment, payment is also made in the third step, either through a link to a site such as PayPal™ (in this case, button 1025) or by collecting credit card information directly. When the advertiser is finished setting up the promotional post, button 1040 triggers publication of the post.

In a preferred embodiment, syndication server 110 monitors social network server 150 to see whose promotional posts have received the most shares or repins. Syndication server 110 may award a prize to the promotional posts which have received the greatest number of shares or repins. In certain embodiments advertisers also may be charged and influencers may also be compensated based on the number of shares or repins.

We claim:

1. A computer-implemented method for syndicating promotional posts on a social networking site from several advertisers to many consumers through several social network influencers' social network feeds, comprising:
receiving at a server a request from an advertiser to syndicate a promotional post;
receiving at the server a request from a social network influencer to post promotional posts on the social network influencer's social network feed;
receiving at the server a login credential of the social network influencer's third-party social network site account;
creating a tracking URL for tracking clickthroughs on the promotional post, wherein the tracking URL is unique to the promotional post and the social network influencer;
responsive to the request from the advertiser, using the login credential to send a request to the third-party social network site to post the promotional post to the social network influencer's third-party social network site account, wherein the request to the third-party social network site includes the tracking URL;
receiving at the server requests to the tracking URL;
causing the advertiser's account to be debited based on the requests received at the tracking URL; and
causing the influencer to be paid based on the requests received at the tracking URL.

2. The method of claim 1, wherein the social network site is an image pinboard site, and the promotional post consists primarily of an image.

3. The method of claim 1, further comprising the step of receiving at the server information from the social network site indicating a number or list of social network users who have shared the promotional post via the social network influencer's social network feed.

4. The method of claim 3, further comprising the step of awarding a prize based on the number or list of social network users who have shared the promotional post via the social network influencer's social network feed.

5. The method of claim 3, wherein the causing the advertiser's account to be debited is also based on the number or list of social network users who have shared the promotional post via the social network influencer's social network feed.

6. The method of claim 3, wherein the causing the influencer to be paid is also based on the number or list of social network users who have shared the promotional post via the social network influencer's social network feed.

7. The method of claim 3, further comprising the step of sending information to the advertiser about the social network users who have shared the promotional post via the social network influencer's social network feed.

8. The method of claim 3, further comprising the step of detecting fraudulent shares via the social network influencer's social network feed.

9. The method of claim 1, further comprising the step of detecting fraudulent requests to the tracking URL.

10. The method of claim 1, further comprising the step of submitting the promotional post to the social network influencer for approval, wherein the promotional post is not displayed on the social network influencer's social network feed unless approval is received from the social network influencer.

11. The method of claim 1, further comprising the steps of:
obtaining a list of the social network influencer's social network feeds from the social networking site;
sending the list of the social network influencer's social network feeds to the social network user;
receiving from the social network influencer an indication of the specific social network feeds on which promotional posts may be posted.

12. The method of claim 1, further comprising the steps of:
receiving a condition for removing the promotional post from the advertiser;
determining that the criterion for removing the promotional post has been met;
based on said determining step, sending a request to the social network site to remove the promotional post from the social network influencer's social network feed.

13. The method of claim 12, wherein the condition for removing the promotional post is based on the amount of money spent on the post.

14. The method of claim 12, wherein the condition for removing the promotional post is based on a predetermined end time.
